(19) United States
(12) Patent Application Publication
(10) Pub. No.: US 2005/0017066 A1
(43) Pub. Date: Jan. 27, 2005

(54) Till control system

(76) Inventor: Kenneth Carter, Naples, FL (US)

Correspondence Address: SPENCER, FANE, BRITT & BROWNE, 1000 WALNUT STREET, SUITE 1400, KANSAS CITY, MO, 64106-2140, US

(21) Appl. No.: 10/867,418

(22) Filed: Jun. 14, 2004

Related U.S. Application Data
(63) Continuation-in-part of application No. 09/731,361, filed on Dec. 6, 2000.

(51) Int. Cl. G06F 17/00; G06F 17/60

(52) U.S. Cl. 235/375; 235/379; 705/11

(57) ABSTRACT

A till control system (1) operable to control, track, and otherwise monitor access to a plurality of currency tills (10) broadly comprises a computer program to track the tills (10), a computer (12) to run the computer program, a weigh scale (14) to measure each till's (10) weight, and a bar code scanner (10) to read indicia (18) on each till (10) thereby uniquely identifying each till (10). The system (1) allows each till 10 to be built more efficiently, by eliminating the need to build the tills (10) to a specified target value. Specifically, the system (1) creates records for each till (10) that are identified through the indicia (18) on each till (10). A somewhat random starting value may be stored in each record and later retrieved, in order to reconcile or balance the tills (10).

### RELATED APPLICATIONS

This application is a continuation-in-part of application Ser. No. 09/616,401, Filed Jul. 14, 2000, titled “REVENUE BALANCING METHOD AND COMPUTER PROGRAM,” which is hereby incorporated into the present application.

### BACKGROUND OF THE INVENTION

1. Field of the Invention

The present invention relates to till control systems. More particularly, the present invention relates to a till control system operable to track and otherwise monitor or control access to a plurality of money tills.

2. Description of Prior Art

Grocery stores and other retail and wholesale business establishments that use cash registers to facilitate sales and other business transactions must regularly stock or “build” cash drawers, or tills, with currency of various denominations for issuance to and use by cashiers, managers, or other personnel. Stores must also periodically reconcile or balance these tills to ensure that cash and coins in these tills accurately reflect sales transactions.

Most businesses typically build tills by manually counting a number or value of each particular denomination of currency. Similarly, most businesses reconcile used tills by manually counting currency from the till. Thus, it will be appreciated that building and reconciling tills is a time and labor intensive activity that may be repeated hundreds of times each day in larger stores. Furthermore, manual counting may result in errors, and when such errors occur it may be necessary to recount the currency in question.

Systems and methods that automate some aspects of building and reconciling tills have been developed. However, since there is currently no way to tell tills apart, these systems and methods continue to require that accounting personnel manually build each till to a specified and fixed starting value, in order to reconcile tills with sales transactions. Fixing starting values allows a transaction total to be calculated as an ending value minus that starting value. However, since extreme care must be taken to achieve the fixed starting value, building tills is still time and labor intensive and prone to miscounting errors.

Accordingly, there is a need for an improved till control system that overcomes the limitations of the prior art.

### SUMMARY OF THE INVENTION

The present invention overcomes the above-identified problems and provides a distinct advance in the art of till control systems. More particularly, the present invention provides a till control system operable to track and otherwise monitor or control access to a plurality of currency tills or cash drawers. The system broadly comprises a computer program to track the tills, a computer to run the computer program, a weigh scale to measure each till's weight, and a bar code scanner or RFID, Bluetooth or any similar communication technology to read indicia on each till thereby uniquely identifying each till.

The computer is operable to create and store records for each till. Specifically, a till record may be created for each till and identified through the indicia on each till. A new till record is preferably created each time any one of the tills are used. For example, each till record may be identified by a unique till tracking number and/or a sequential number that is incremented each time one of the tills is used. Alternatively, the till record for a particular one of the tills may be initialized each time that till is used, thereby erasing any previous record for that till. In any case, the till records are used to store a starting value and other information for each till, as will be discussed in further detail below.

The weigh scale is operable to weigh an empty till placed thereon, currency placed in the empty till, and containers of loose coins. In an alternative embodiment, currency may also be placed directly on the weigh scale. The weight range of empty tills can be pre-determined and stored in memory accessible by the computer so that the computer program can subtract this weight to determine the weight of the currency placed in tills on the weigh scale. Alternatively, the empty till's weight may be determined each time the system is used.

While the tills may otherwise be completely conventional, the tills include the indicia uniquely indicative of each till. For example, in a preferred embodiment, the indicia comprises a unique bar-code sticker/RFID affixed to each till. In this embodiment, the scanner reads a unique bar-code or RFID on each sticker in order to recognize a unique till identifier, such as the till tracking number, used to uniquely identify each till and the till record associated with that till.

The system may be used to efficiently build the tills. Building tills comprises adding currency of several denominations to an otherwise empty till until reaching the starting value. A till built to the starting value is commonly referred to as a ‘clean till’. Once the till has been used by a cashier to handle sales transactions, or a manager to make change, that till is then referred to as a ‘dirty till’ and has an ending value.

A transaction total, which represents results of the sales transactions made with that till, is calculated as the ending value minus the starting value. For example, a clean till containing $152, is given to a cashier at the beginning of his or her shift. At the end of that cashier's shift, he or she returns a dirty till containing $402. In this example, the starting value is $152, the ending value is $402, and the transaction total is $250. The transaction total is normally balanced against receipts that also reflect the results of the sales transactions, for that cashier.

Currently, since prior art tills are not uniquely identifiable, the only way to calculate the transaction total is to fix the starting value for each till at a specified target value. This allows the transaction total to be calculated and balanced against the receipts. However, building each till to the specified target value using specified numbers of each denomination is tedious and time consuming.

The system of the present invention allows each till to be built more efficiently. For example, the starting value of the tills need not be fixed at the specified target value, since the tills may be uniquely identified using the indicia. In fact, since the computer stores and can later retrieve the starting value for each till, each till may have a different starting value. Therefore, an operator only needs to try to ensure that each till gets an adequate supply of currency, and need not try to make the starting value match the specified target value exactly. Thus, the operator does not have to add specified numbers of different denominations to each till, thereby saving a considerable amount of time, particularly when building several tills.

As the operator builds each till, the operator may be required to inform the computer what denomination of currency is currently being added, so that the computer program can accurately count the currency, by weight. For example, the operator may inform the computer that he or she is now adding $1 bills to the till. In this case, the computer would increment the starting value by $1 for each bill weighed using the weight scale. Then, the operator may inform the computer that he or she is now adding $5 bills to the till. In this case, the computer would increment the starting value by $5 for each bill weighed. This process would be followed for each denomination of currency. It should be obvious that the operator may add several bills or coins simultaneously, since the computer counts by weight, not iteration.

In use, the operator scans one of the tills using the scanner, or by using other similar technologies, thereby uniquely identifying that till to the computer, and places that till on the weight scale. The computer then initializes or creates the record for that till. The operator builds that till to the starting value, which is not equal to any specific value, may be somewhat random, and may be different for each till, thereby creating the clean till.

Once the clean till is created, the operator informs the computer. The computer then stores the starting value in the till record created for that till. The operator then issues the till to one of the cashiers. The operator may also record information indicative of the cashier to which that till is issued, such as an operator identifier, thereby causing the computer to store the operator identifier in the till record for that till. At this point, the till has been efficiently created and issued. Information, such as the till identifier, the starting value, and the operator identifier has been stored in the record in the computer. In this manner, initialization of and access to the till has been tracked by the system.

When the cashier returns the till, as a dirty till, at the end of his or her shift, the operator again scans the indicia or uses another communication technology, thereby identifying that till and retrieving the starting value for that till. The operator then transfers the currency from that till to the weigh scale, either directly or using another empty till, while informing the computer what denomination of currency is currently being transferred, thereby counting the currency in that till and determining the ending value for that till. With the starting value, as retrieved from the computer, and the ending value, the system may then determine the transaction total, which may be balanced against the receipts for that cashier.

### BRIEF DESCRIPTION OF THE DRAWINGS

A preferred embodiment of the present invention is described in detail below with reference to the attached drawing figures, wherein:

FIG. 1 is a block diagram of a till control system constructed in accordance with a preferred embodiment of the present invention;

FIG. 2 is an elevation view of a front of a till enclosure that may be used with the present invention; and

FIG. 3 is an elevation view of a back of the till enclosure.

### DETAILED DESCRIPTION OF A PREFERRED EMBODIMENT

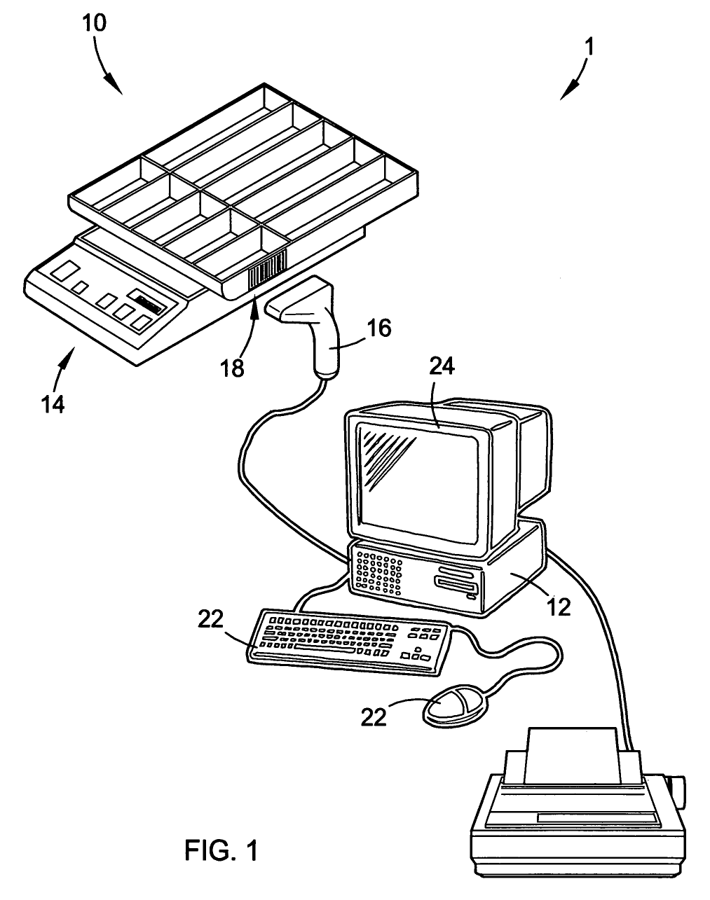

Referring to FIG. 1, a till control system 1 is shown constructed in accordance with a preferred embodiment of the present invention and operable to track and otherwise monitor or control access to a plurality of currency tills 10. The invention broadly comprises a computer program to track the tills 10, a computer 12 to run the computer program, a weigh scale 14 connected to the computer 12 and operable to measure each till's 10 weight, and a bar code scanner 16, RFID, Bluetooth or other communication technology is connected to the computer 12 and operable to read indicia 18 on each till 10 thereby uniquely identifying each till 10. The computer 12, weigh scale 14, and scanner 16 are preferably housed in or on a metal cabinet for ease of use and protection. Certain aspects of the present invention are described in more detail in co-pending patent applications entitled “Revenue Balancing Method and Computer Program”, Ser. No. 09/616,401, filed Jul. 14, 2000 and “Method and computer program for building and replenishing cash drawers with coins”, Ser. No. 09/832,509, filed Apr. 11, 2001, hereby incorporated into the present application by specific reference.

The term “till” may include cash drawers used in cash registers or any other type of drawer, holder, or enclosure that is used to hold, receive, and dispense currency in connection with sales transactions. The currency may include different denominations of paper currency and coins. For example, paper currency may include denominations of $1 bills, $5 bills, $10 bills, $20 bills, $50 bills, and $100 bills. Similarly, coins may include denominations for pennies, nickels, dimes, quarters, and dollar coins. The currency is not limited to U.S. currencies, but may include currencies from any country's monetary system.

The computer program may be implemented in any suitable high or low level computer language, such as C++, Java, or Assembly, and stored on any suitable computer readable media accessible to the computer 12, such as optical or magnetic disk. The computer program may be easily adapted for use with other systems and software, such as an employee time and attendance system, a labor scheduling system, a point-of-sale (POS) system, or a till balancing system. By integrating such systems a complete picture of the work environment can be developed, which facilitates maximizing efficiency. For example, while an employee's log-on and log-off times from a register are preferably recorded by the POS system, their till check-out and return times may be recorded by the present invention. Integrating these systems and comparing the differences in times will allow employers to spot costly time-tracking abuses.

The computer 12 controls operation of and/or receives inputs from the weigh scale 14 and the scanner 16 in accordance with instructions from the computer program. The computer 12 may be any computing device, such as an IBM compatible personal computer including those manufactured and sold by Dell, Compaq, Gateway, or any other computer manufacturer. The computer 12 preferably includes or is coupled with conventional input devices 22, such as a keyboard and a computer mouse. The computer 12 is also preferably coupled with a computer monitor 24 or screen. The preferred monitor 24 is a flat-screen monitor such as the model number BP350 monitor sold by Sceptre.

The computer 12 is further operable to create and store records for each till 10. Specifically, a till record may be created for each till 10 and identified through the indicia 18 on each till 10. A new till record is preferably created each time any one of tills 10 are used. For example, each till record may be identified by a unique till tracking number and/or a sequential number that is incremented each time one of the tills 10 is used. Alternatively, the till record for a particular one of the tills may be initialized each time that till 10 is used, thereby erasing any previous record for that till 10. In any case, the till records are used to store a starting value and other information for each till 10, as will be discussed in further detail below.

The weigh scale 14 is coupled with the computer 12 through a serial, parallel, or Universal Serial Bus (USB) port on the computer 12 and is used for weighing the currency and providing corresponding weight signals to the computer 12 as described in more detail below. The weigh scale 14 may be any conventional scale that is capable of accurately weighing the paper currency. The preferred scale is a 3000 gram scale manufactured by Ishiba Company Limited. A 6200 gram scale may be preferable to accommodate $1, $5, and $10 coins.

The weigh scale 14 is operable to weigh an empty till placed thereon, currency placed in the empty till, and containers of loose coins. In an alternative embodiment, currency may also be placed directly on the weigh scale 14. The weight range of empty tills can be pre-determined and stored in memory accessible by the computer 12 so that the computer program can subtract this weight from other weight measurements to determine the weight of the currency placed in tills 10 on the weigh scale 14. Alternatively, the empty till's weight may be determined each time the system 1 is to be used.

In addition, all possible currency that is to be counted with the present invention can also be weighed if the items are consistent in weight and value. For example, while different denominations of paper currency have substantially identical weights, different denominations of coins have substantially different weights. The weight measurements for the different types of currency may be stored in the computer 12, or memory accessible by the computer 12, so that the computer program can distinguish between the different types of currency that are weighed by the weigh scale 14 in order to count the currency as the currency is placed in the till 10.

While the tills 10 may otherwise be completely conventional, the tills 10 include the indicia 18 uniquely indicative of each till 10. For example, in a preferred embodiment, the indicia 18 comprises a unique bar-code sticker affixed to each till 10. In this embodiment, the scanner 16, RFID, Bluetooth or any similar technology reads a unique bar-code on each sticker in order to recognize a unique till identifier, such as the till tracking number, used to uniquely identify each till 10 and the till record associated with that till. In alternative embodiments, the indicia 18 may include other uniquely indicative stickers or labels. Furthermore, the indicia 18 may be molded or otherwise formed into each till. The indicia 18 may also comprise electronic radio frequency tags that receive and respond to radio frequency signals received from the scanner 16.

In any case, the scanner 16, RFID, Bluetooth or similar technology is chosen to read or otherwise detect the indicia 18 in order to uniquely identify each till 10 according to the till identifier. Thus, the scanner 16 and indicia 18 provide the ability to track custody of each till 10 and allow for greater control over accountability of funds, which is particularly useful when discrepancies arise.

The system 1 is preferably used to efficiently build the tills 10. Building tills comprises adding currency of several denominations to an otherwise empty till until reaching the starting value. For example, tills are currently built to a specified target value, such as $152, using specified numbers of each denomination of currency. A till built to the starting value is commonly referred to as a ‘clean till’. Once the till has been used by a cashier to handle sales transactions, or a manager to make change, that till is then referred to as a dirty till and has an ending value.

A transaction total, which represents results of the sales transactions made with that till, is calculated as the ending value minus the starting value. For example, a clean till containing $152, is given to a cashier at the beginning of his or her shift. At the end of that cashier's shift, he or she returns a dirty till containing $402. In this example, the starting value is $152, the ending value is $402, and the transaction total is $250. The transaction total is normally balanced against receipts, that also reflect the results of the sales transactions, for that cashier.

Since prior art tills are not uniquely identifiable and are substantially indistinguishable, the only way to calculate the transaction total is to fix the starting value at the specified target value. However, building each till 10 to the specified target value using the specified numbers of each denomination is time consuming and tedious.

The system 1 of the present invention allows each till 10 to be built more efficiently, by eliminating the need to build the tills 10 to the specified target value. More specifically, the starting value of the tills' 10 need not be fixed at the specified target value, since the tills 10 may be uniquely identified using the indicia 18. In fact, since the computer 12 stores and can later retrieve the starting value for each till 10, each till 10 may have a different starting value. Therefore, an operator only needs to try to ensure that each till 10 gets an adequate supply of currency, and need not try to make the starting value match the specified target value exactly. Thus, the operator does not have to add the specified numbers of the different denominations to each till 10, thereby saving a considerable amount of time, particularly when building several tills 10.

In use, the operator scans one of the tills 10 using the scanner 16, RFID, Bluetooth or similar technologies, thereby uniquely identifying that till 10 to the computer 12. The computer 12 then initializes or creates the till record for that till 10. The operator then places that till 10 on the weight scale 14, in order to count the currency as the currency is added to that till 10. The operator builds that till 10 to the starting value, which is not equal to any specific value, may be somewhat random, and may be different for each till 10, thereby creating the clean till.

As the operator builds each till 10, the operator may be required to inform the computer 12 which denomination of currency is currently being added, so that the computer program can accurately count the currency, using the weight scale 14. For example, the operator may inform the computer 12 that he or she is now adding $1 bills to the till 10. In this case, the computer 12 would increment the starting value by $1 for each bill detected by the weight scale 14. It should be obvious that the operator may add several bills simultaneously, since the computer 12 counts by weight, not iteration. Then, the operator may inform the computer 12 that he or she is now adding $5 bills to the till 10. In this case, the computer 12 would increment the starting value by $5 for each bill weighed. This process would be followed for each denomination of paper currency.

A nearly identical process would be used for coins. The most significant difference is that the computer 12 may double check the operator. For example, if the operator informs the computer 12 that he or she is now adding quarters to the till 10 and the weight scale 14 indicates a change in weight not compatible with increments expected from quarters, the computer 12 may so inform the operator through the monitor 24 or another means. This allows the operator to be sure that he or she is indeed adding quarters and that other coins have not been added by mistake.

The operator informs the computer 12 when he or she is finished adding currency, such as by pressing a key on the keyboard 22, thereby completing creation of the clean till. The computer 12 then stores the starting value in the till record created for that till 10. The operator then issues the till 10 to one of the cashiers. The operator may also record information indicative of the cashier to which that till is issued, such as an operator identifier, thereby causing the computer 12 to store the operator identifier in the till record for that till 10. At this point, the till 10 has been efficiently created and issued. Information, such as the till identifier, the starting value, and the operator identifier has been stored in the till record in the computer 12. In this manner, creation of and access to the till 10 has been tracked by the system 1.

When the cashier returns the till 10, as a dirty till, at the end of his or her shift, the operator again scans the indicia 18, thereby identifying that till 10 and retrieving the starting value for that till 10. The operator then transfers the currency from that till 10 to the weigh scale 14, either directly or using another empty till, while informing the computer 12 what denomination of currency is currently being transferred, thereby counting the currency in that till 10 and determining the ending value for that till 10. With the starting value, as retrieved from the computer 12, and the ending value the system 1 may determine the transaction total, which may be balanced against the receipts for that cashier.

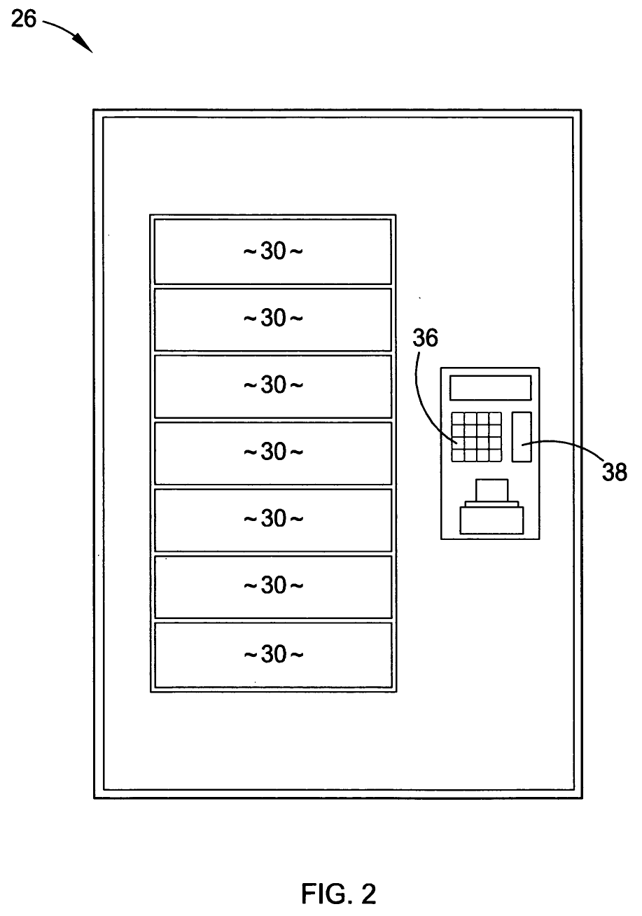

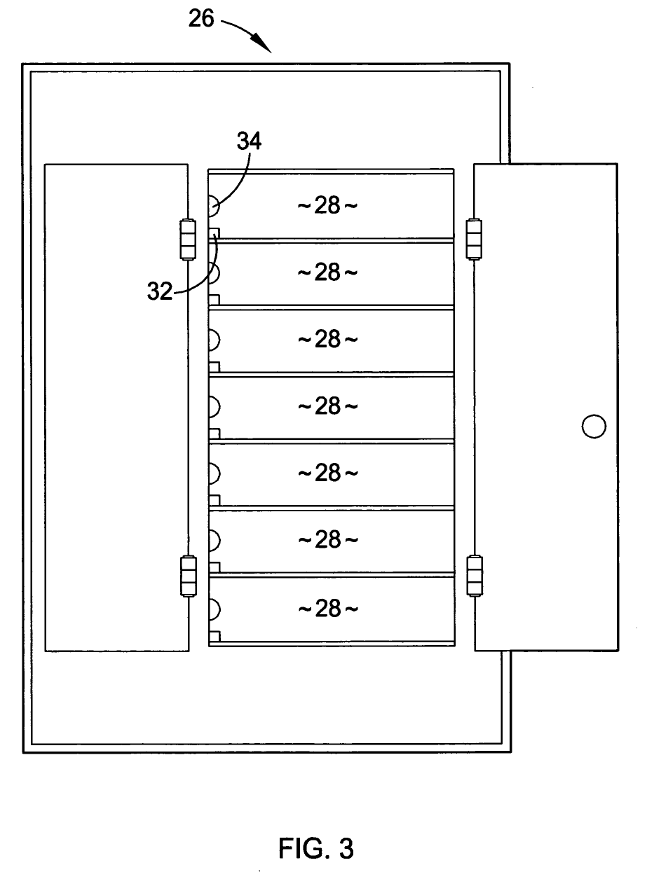

In a slightly more complex embodiment, also referring to FIGS. 2-3, the system 1 may include a till enclosure 26 to provide a protective housing for several of the tills 10. The enclosure 26 may be divided so as to define till compartments 28, as more fully disclosed in the patent application entitled “Revenue Balancing Method and Computer Program” and referenced above. In this case, the enclosure 26 includes a plurality of hingedly-mounted doors 30, with each door 30 operable to securely close the front of a corresponding compartment 28 and to thereby allow only controlled access to that compartment 28 via the door 30 of the enclosure 26.

The number, size, and shape of the compartments 28 are matters of design, though minimum compartment dimensions are limited by the size and shape of the tills 10 to be received therein. Door sensors 32 may be used to sense the position of each door 30, whether open or closed, and report such to the computer 12. Till detectors 34 may also be used to detect the presence of tills 10 in each compartment 28 and report such to the computer 12.

A keypad 36 is preferably used to provide sufficient alphanumeric keys to allow any one of the cashiers to enter the operator identifier, such as an employee ID number and/or password, in order to identify him or herself to the computer 12. A second identification device 38 may also be included for accepting, identifying, or validating the operator identifier in other forms, such as a card reader, a fingerprint scanner, or an optical scanner.

Clean tills are loaded into a rear of the enclosure 26. Each till 10 is identified using the indicia 18 and assigned to one of the compartments 28. This may be accomplished automatically using a bar code scanner incorporated into each compartment 28 to read the indicia 18 as each till 10 is placed therein. Alternatively, each compartment 28 may have indicia similar to the indicia 18 on the tills 10. In this case, the indicia on the compartment 28 may be scanned with the scanner 16 to inform the computer 12 in which compartment 28 each till 10 is placed. In either case, the computer 12 preferably updates the till records by adding an indication of which compartment 28 holds the associated till 10.

A cashier needing one of the clean tills approaches the keypad 36 and enters his or her operator identifier. The operator identifier is sent from the keypad 36 to the computer 12 where it is matched to information stored therein. The computer 12 then checks for, among other things, authorization to receive the till 10. This step also allows the computer 12 to track the cashier's time in receipt of the till 10. Once authorization is complete the computer 12 assigns one of the clean tills to the cashier. The computer 12 also updates the associated till record by adding the cashier's operator identifier, thereby tracking access to the till 10. The computer 12 then sends an actuation signal to an appropriate solenoid to open the door 30 to an appropriate one of the compartments 28 and allow access to the till 10 stored therein.

Thus, the computer program receives the operator identifier, assigns one of the tills 10 in the enclosure 26 to the cashier, and allows the cashier to access the assigned till 10. In this manner, the system 1 actively controls distribution of the tills 10 from the enclosure 26.

A cashier returning a dirty till approaches the keypad 36 and enters his or her operator identifier. The computer 12 will designate one of the compartments 28 to receive the till 10 and updates the till record to reflect in which compartment 28 the till 10 is to be placed, thereby further tracking the till 10. The computer 12 also sends an actuation signal to the appropriate solenoid to open the door 30 of the designated compartment 28. The operator then places the till 10 in the designated compartment 28 and closes the door 30.

Thus, the computer program receives the operator identifier, designates one of the compartments 28 to receive the cashier's till 10, and allows the cashier to access the designated compartment 28. In this manner, the system 1 actively controls receipt of the tills 10 into the enclosure 26.

A tremendous advantage of the present invention is that it allows detailed record-keeping related to till management. For example, the computer 20 may process and keep related information, such as records regarding the times the cashiers received and returned the tills 10. Whenever one of the tills 10 is received or returned by one of the cashiers, a cashier record may be generated with relevant information, including time in and time out. The cashier records may be stored and updated for later recall and analysis. The computer program is operable to generate reports based upon such stored information. These reports can be viewed on the monitor 24 or printed on a printer.

While the present invention has been described above, it is understood that substitutions may be made. For example, the computer program and computer 12 illustrated and described herein are merely examples of a program and equipment that may be used to implement the present invention and may be replaced with other software and computer equipment without departing from the scope of the present invention. For instance, the computer program of present invention can be implemented in hardware, software, firmware, or a combination thereof. These and other minor modifications are within the scope of the present invention.

1. A till control system for tracking a plurality of tills, the system comprising:
indicia operable to be joined with each of the tills and uniquely indicative of each of the tills; and
a sensor operable to read the indicia in order to uniquely identify each of the tills.

2. The system as set forth in claim 1, further including a computer program operable to uniquely identify each of the tills through the sensor and thereby monitor access to the tills.

3. The system as set forth in claim 2, further including a computer operable to run the program and interface with the sensor.

4. The system as set forth in claim 2, wherein the computer program is further operable to store a starting value for each till.

5. The system as set forth in claim 4, wherein the starting value is an unspecified value of currency.

6. The system as set forth in claim 4, wherein the starting value is approximately but not exactly equal to a specified target value and may be different for each till.

7. The system as set forth in claim 4, further including an electronic scale operable to measure a weight of each till in order to determine the starting value.

8. The system as set forth in claim 4, wherein the computer program is further operable to store a till record for each till in which the starting value may be stored for future retrieval.

9. The system as set forth in claim 2, wherein the computer program is further operable to store a till record for each till in which a till identifier may be matched with an operator identifier thereby identifying to whom each till is assigned in order to track each till.

10. The system as set forth in claim 1, further including an electronic scale operable to measure a weight of the till in order to determine a starting value and an ending value for each till.

11. The system as set forth in claim 10, further including—
a computer program operable create a till record for each till, store each till record, and retrieve each till record according to a till identifier, which uniquely identifies each till and is recognizable through the sensor.
a computer operable to run the program and interface with the sensor and the scale to track the tills and determine the starting value and the ending value for each till.

12. The system as set forth in claim 11, wherein each till record is used to store the starting value and an operator identifier identifying to whom each till is assigned.

13. A method of efficiently building a till, the method comprising the steps of:
uniquely identifying the till in order to track the till; and
counting an unspecified value of currency added to the till.

14. The method as set forth in claim 13, wherein the unspecified value is approximately but not exactly equal to a specified value.

15. The method as set forth in claim 13, further including the step of assigning the till to a cashier by storing an operator identifier with the unspecified value in a computer.

16. The method as set forth in claim 13, further including the step of storing the unspecified value in a computer as a starting value.

17. The method as set forth in claim 16, further including the steps of—
issuing the till to a cashier,
receiving the till from the cashier, and
determining an ending value of the till.

18. The method as set forth in claim 17, further including the step of retrieving the starting value from the computer.

19. The method as set forth in claim 17, further including the step of calculating a transaction total by subtracting the starting value from the ending value.

20. A method of efficiently building a till, the method comprising the steps of:
identifying the till using a scanner to scan indicia joined with the till, thereby recognizing a till identifier associated with the till;
determining a starting value of the till using a weigh scale;
identifying a cashier using an operator identifier;
assigning the till to the cashier;
storing the operator identifier, the starting value, and the till identifier in a till record;
issuing the till to the cashier;
receiving the till from the cashier;
determining an ending value of the till using the weight scale;
retrieving the starting value; and
calculating a transaction total by subtracting the starting value from the ending value.
